(19) United States
(12) Patent Application Publication
(10) Pub. No.: US 2004/0020247 A1
(43) Pub. Date: Feb. 5, 2004

(54) Antitheft device for skis

(76) Inventors: Bruno Rampinelli, Albino (IT); Claudio Austoni, Bagnatica (IT)

Correspondence Address: NIXON & VANDERHYE, PC, 1100 N GLEBE ROAD, 8TH FLOOR, ARLINGTON, VA, 22201-4714, US

(21) Appl. No.: 10/406,583

(22) Filed: Apr. 4, 2003

(30) Foreign Application Priority Data
Apr. 11, 2002 (EP) 02425224.9

(51) Int. Cl. E05B 69/00; E05B 73/00

(52) U.S. Cl. 70/58; 70/62

(57) ABSTRACT

Anti-theft device for skis comprising a box-like element that can be opened, provided with locking means and in the inside with a groove to house the skis, accessible through an opening of the box-like element. The groove comprises at least a section narrowing point and has a length of at least 150 mm.

The present invention relates to an anti-theft device for skis.

As is known, during the days on ski slopes, one needs often to stop and pause in huts or bars located on the slope edge, to refresh and have a rest. In such situation, skis, that are generally very expensive, are left unguarded, within the reach of ill-intentioned people outside said huts. Besides, should one wish to stop skiing to visit the town or, for instance at the end of the day, to go shopping or to visit some other facility, it is necessary to leave skis unguarded, with an ensuing theft risk. In these conditions, it is necessary to stop at the hotel, the dwelling place or other suitable places to deposit skis at a secure place.

To solve this problem, anti-theft devices for skis have been proposed that are constituted of a rack made up by two elements. In detail, a seat located in correspondence of the ground to house the ski tail and a closing ring that can be opened and that locks the skis above the bindings. The rectangular-meshed closing ring has a standard size, in order to house skis having a different conformation and width. The standard size of the ring allows the same not to adhere to skis, and for this reason, the lock of the same is necessarily obtained by the assembly of both elements. In particular, said ring, when skis are in a closed device position being located above bindings, prevents skis from being slipped off from the top, while the base seat, purposely located at some distance from the ring, locks tails to prevent skis from being slipped off from the bottom.

However, this anti-theft device does not solve skis' security problem, as if one should be able to take off the ski tail from the base seat, it would be easy to slip off skis by pulling them downwards from the upper closing ring. In some well-equipped ski resorts, at the start-facilities of cable-ways and the like, premises are provided that have sheet lockers where skis can be left. Generally, these lockers are very bulky and require therefore wide spaces for their installation; besides, they are closed by means of simple locks or padlocks, that are certainly not thief-proof.

Object of the present invention is to solve the problems of the known art by providing a secure anti-theft device for skis, suitable to adjust to any types of skis.

Another object of the present invention is to provide an anti-theft device for skis whose production is simple and economical and also whose use is easy and intuitive.

Still another object of the present invention is to provide a device that, thanks to its small size, is not bulky and does not require a wide space to be installed.

And lastly, another object of the present invention is to realize a device that can be indifferently installed in the inside and/or outside of any premises without requiring any modification thereof.

These and still other objects are achieved by the present invention that relates to an anti-theft device for skis, comprising a box-like element that can be opened, provided with locking means and, in the inside, with a groove for housing skis, accessible by opening the box-like element, characterized in that said groove comprises at least a section narrowing point.

Always according to the invention, said groove has a length of 150 mm at least.

The device allows to lock in a secure manner skis and in particular the ski portion comprised between the upper part of the binding, suitable to lock the tip of the ski boot, and the tips of the skis, in the inside of the box-like element. With such device, made up advantageously by one only element, it is in fact impossible to remove the skis by slipping them off from the top of the box-like element because of the presence of the bindings that are located in the underlying part, and is as much impossible to slip them off from the lower portion because the section narrowing point and the length of the groove and of the same device prevent their extraction without breaking the skis.

According to a preferred aspect of the present invention, the groove has a U-shaped cross-section and side walls arranged each according to a broken line.

The broken lines are symmetrically arranged with respect to the longitudinal axis of the groove, and subdivide said groove, for instance, into three portions.

Advantageously, the groove comprises at least a portion having side walls that converge towards the center of the groove and at least a portion having divergent side walls.

According to another preferred aspect of the invention, the groove for ski-housing has the shape of an inner body removable with respect to the box-like element. This allows the replacement of the portion of the anti-theft device that is more subject to wearing, i.e. the inner removable body, without replacing other elements of the device that have a longer working life.

According to an advantageous aspect of the present invention, the removable inner body is made from thermoplastic vinyl resin. Such resins may be repeatedly molten to reproduce the part desired up to 15-20 times, without loosing their physical and/or mechanical characteristics. For this reason, if the removable inner body of the device should be worn after a period of use, it would be possible to melt it again to realize a new one. It ensues from this that the cost of such portion of the anti-theft device is very contained.

Besides, the high flexibility of vinyl resin allows to protect skis, and in particular the edges, from damages possibly due to the touch of the same with portions of the device made from a rigid material.

Further characteristics and advantages of the present invention will be better understood thanks to the following description made only by way of non limiting illustration, with reference to the attached schematic drawings, wherein:

FIG. 1 is a schematic front view of the device according to the present invention, in a closed configuration on a ski pair;

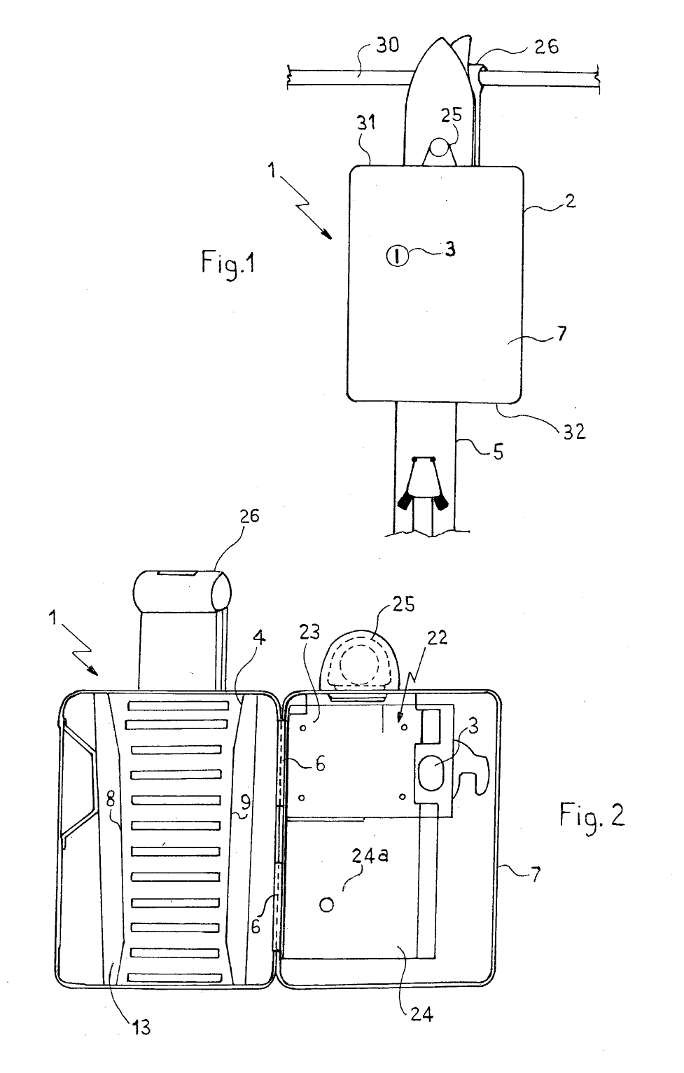

FIG. 2 is a schematic front view of the device according to the present invention, in an open configuration:

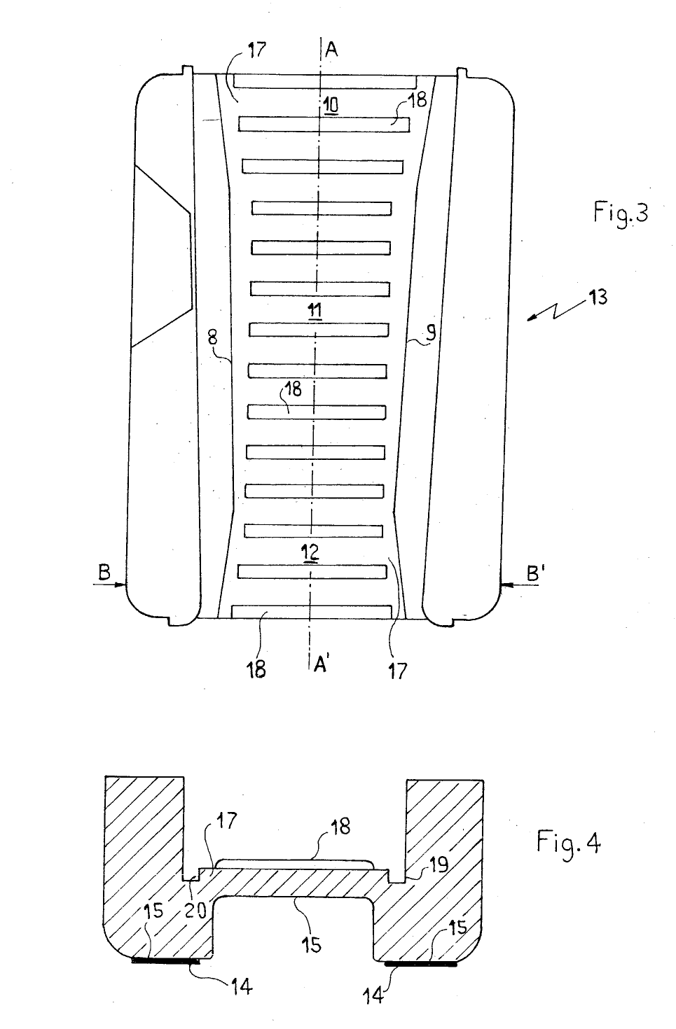

FIG. 3 is a front view of the inner removable body according to the invention;

FIG. 4 is a cross-view according to line B-B′ of FIG. 3;

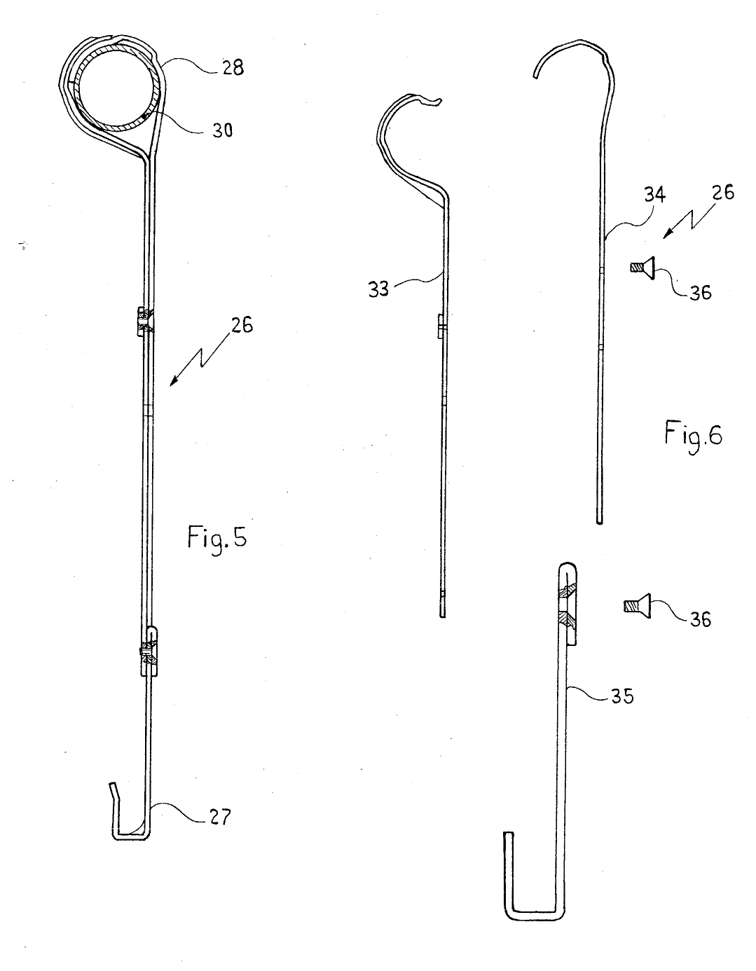

FIG. 5 is an overall view of a supporting means according to the invention; and

FIG. 6 is an exploded view of the supporting means of FIG. 5.

FIG. 1 shows a possible embodiment of an anti-theft device 1, according to the present invention, comprising a box-like 2 that can be opened and that is provided with locking means 3, and that is provided in the inside with a longitudinal groove 4 (see FIG. 2) to house a ski pair. Groove 4 for ski-housing is accessible only by opening the box-like element that has advantageously for this purpose a book-like opening. In other words, the box-like element is provided, for instance as shown in FIG. 2, with a couple of hinges 6 that allow to rotate the front portion 7 of the box-like element to allow the opening thereof. Groove 4 has at least a section narrowing point that allows to lock in its inside skis of any conformation and width, and has a length of at least 150 mm. Preferably, the length of the groove is of at least 200 mm.

Obviously, the length of the inner groove affects the whole length of the box-like element.

In order to facilitate ski-housing, the groove has a U-shaped cross-section and side walls arranged each according to a broken line. In particular, as shown in FIGS. 2 and 3, the side walls 8, 9 of groove 4, are arranged according to two broken lines symmetrical with respect to the longitudinal A-A′ axis of the groove, so as to subdivide groove 4 into three portions 10, 11 and 12.

The arrangement of side walls 8, 9 of groove 4 along broken lines symmetrical with respect to the longitudinal A-A′ axis of said groove 4, allows to obtain portions 10, 11 and 12 having different cross-sections. In other words, the cross-section of the groove has not a constant size throughout the extension of groove 4. In particular, groove 4 has not a constant cross-size.

Two 10, 11 out of the three portions into which groove 4 is subdivided have convergent side walls and a portion 12 has divergent side walls, so that the groove has, from top downwards, two tapers that converge towards the longitudinal central A-A′ axis and a flaring that diverges with respect to the central longitudinal A-A′ axis of said groove.

In an alternative embodiment, not shown, the base wall 17 of groove 4 has an inclined portion in order to obtain a greater adhesion between the skis and the walls of the groove. In detail, the base wall 17 of groove 4 has a length inclined by about 15° with respect to the base wall. Always according to the invention, further inclinations are possible.

Ski-housing groove 4 is realized, as can be seen in FIG. 3, in the shape of an internal body 13 removable from the box-like element 2, and in particular said internal body 13 is made from a thermoplastic vinyl resin. Preferably, the internal body 13, detachable with respect to the box-like 2, is made from polymerized PVC. Such resin can be molten repeatedly to reproduce the desired part up to at least 15-20 times without loosing its physical and/or mechanical characteristics and for such reason, if the internal body 13 of the device should be worn, it would be possible to melt it again to obtain a new one. This allows to replace the most wearable part of the anti-theft device 1, namely the internal body 13, without having recourse to the replacement of the whole device.

Alternatively, the removable internal body 13 may be realized from any materials ensuring a high mechanical resistance, a non-deformation property between +50° C. and −40° C., being at the same time so flexible as not to damage the skis or their edges.

The removable body 13 has a shape and size that correspond to the shape and size of the box-like element 2, and for this reason the removable body 13 fits in the latter. In any case, in order to ensure a better seal between the box-like element 2 and the removable internal body 13, fastening means 14 are provided. In detail, in the embodiment shown in FIG. 4, the fastening means are represented by Velcro® strips interposed between the external surface 15 of the removable body 13 and the internal surface, not shown, of the box-like element 2.

To prevent snow or ice from remaining attached between the ski bottom and wall 17 of the groove, the latter is provided with cross-ribs 18.

Besides, to facilitate the dripping of skis and the flow towards the outside of water deriving from snow that melts from skis, two drain channels 19, 20 (FIG. 4) that extend in the inside of groove 4 throughout its length are provided at the base of side walls 8, 9 of groove 4.

The box-like element 2 is made from iron sheet having a 2 mm thickness. Such thickness of the iron sheet ensures the almost full inviolability of device 1 that can be opened, lacking the key or other suitable means, only with oxyhydrogen flame. Alternatively, the box-like element may be made from any materials having similar resistance characteristics, such as carbon, titanium, stainless steel or particularly resistant plastics that will not deform at temperatures ranging from +50° C. and −40° C.

Once skis are inserted in the special groove 4, the closing of the box-like element 2 is ensured by special locking means such as a key-lock 3. Given the particular climatic conditions which the device is subject to, lock 3, besides having a particular resistance against tampering, must also be able to work at temperatures close to −40° C.

As can be better seen in FIG. 2, the box-like element 2 can have a coin-actionable device 22 for the release of the key. These devices, that are easy to be found commercially, allow to extract the key from lock 3 once it is closed only on prior introduction of an amount of coins whose value is equal to a prefixed amount. In detail, device 22 has a fixed part 23 and a movable part 24.

The fixed part 23 comprises slot 25 for the insertion of coins and a control element (not shown directly), to make sure that the amount of coins is equal to the quantity due.

Instead, the mobile part comprises a money-box drawer 24a that can be extracted from the device and that is suitable to gather the coins inserted in the release device 22. From time to time, the money-box drawer 24a is extracted from device 22 to allow its emptying.

Different types of suitable release devices are commercially available that are based on the same operation principle, in particular there are also some that are activated by bank-notes and other ones by a magnetic card.

The anti-theft device for skis 1 is provided with different support systems to allow its installation on different supporting structures.

For instance, to fasten the device to a rod 30, a shaped element 26 is provided that has an end 27 that can be fixed in a seat of the box-like element 2, and end 28 that can be engaged with said rod 30. In detail, element 26 has the shape of a thin and elongated slab, provided, in correspondence of end 28, with a tubular seat suitable to house a rod 30 and, in correspondence of the opposite end 27, with a hook-like element suitable to engage a portion of the box-like element 2.

The seat of the box-like element 2, suitable to house the supporting rod, is defined by two slots (not shown) located in a position corresponding on the upper side 31 respectively the lower side 32 of the box-like element 2, by the internal rear wall of the box-like element (not shown) and the external wall 15 of the removable body 13 (FIG. 4). The external wall 15 of the removable body has a shaped profile, to house better the supporting device 26.

The hook-shaped portion 27 protrudes from the slot obtained on the lower side 32 of the box-like element 2, to wind up a portion of the corner defined by the lower side 32 and the rear wall (not directly visible) of the box-like element.

The winding up of the hook-like portion 27 on the lower corner of the box-like element 2 determines the support of the anti-theft device 1 to rod 30, but does not lock the mutual position between the shaped element 26 and the box-like element 2. In this way, the box-like element 2 can slide along a portion of the length of the shaped element 26, in order to better adjust to skis of any height and conformation.

In order to facilitate the insertion of the shaped element 26 in the inside of the special seat, the shaped element is made up, as can be seen in FIG. 6, by three separate parts 33, 34, 35 that may be associated with each other to define the tubular seat 28 and the hook-like portion 27.

The three parts 33, 34, 35 are mutually united by conventional means such as screws 36. Such screws 36, once the shaped element 26 is assembled, on prior insertion and assembly in the special seat, remain concealed and protected in the inside of the box-like element, and therefore it is impossible to act thereon without opening the device. Obviously, many modifications and variants may be introduced in the embodiment described above, without falling outside the protection scope of the same; by way of example, it is possible to have at least a further hole for screw 36 that associates portion 35 of the shaped element 26 with portion 33 thereof. In this way, it is possible to adjust the vertical position of the box-shaped element with respect to the supporting element 26.

This allows, during the assembly, to change the position of the box-like element with respect to the supporting rod 30, so as to adjust more comfortably the device to skis of different height.

A further embodiment is provided with a dovetail fit between the member 35 and the member 33, which fit couples the element 34. In particular, according to this embodiment, the dovetail fit is obtained by providing the surface of the member 35 with a upper converging groove (female recess), nearby bores for screws 36, and by providing a corresponding solid downward divergent projection (male protuberance) on the member 33 surface. Such a fit provides a support for the member 35 which, during the assembly phase and before screws 36 insertion, can be hanged to coupled members 33 and 34. This allows a single person to assembly the support member obtained by coupling elements 33, 34 and 35, which are pendent from the bar 30, without the necessity to simultaneously hold them all when he has to screw screws 36.

Besides, according to an alternative embodiment, if one should wish to install the device on any wall whatever or on uprights, there is provided, as a supporting element, a rectangular plate that can be fixed to the rear part of the box-like element and to any wall whatever. Said plate, not directly shown, is united to the box-like element by means of screws and bolts, screwed from the inside and/or the outside of said box-like element, in such a manner as to remain concealed and protected.

1. An anti-theft device for skis comprises a box-like element that can be opened, provided with locking means and, in the inside, a groove for housing the skis, accessible through an opening of the box-shaped element, characterized in that said groove comprises at least a section narrowing point.

2. The anti-theft device for skis according to claim 1, characterized in that it has a length of at least 150 mm.

3. The anti-theft device for skis according to claim 1, characterized in that said groove has a U-shaped cross-section and side walls arranged each according to a broken line.

4. The anti-theft device for skis according to claim 3, characterized in that said broken lines are arranged symmetrically with respect to the longitudinal axis of the groove and subdivide said groove into three portions.

5. The anti-theft device for skis according to claim 4, characterized in that said groove comprises at least a portion with side walls converging towards the center of the groove and at least a portion with divergent side walls.

6. The anti-theft device for skis according to any of the preceding claims, characterized in that the base wall of said groove comprises at least an inclined portion.

7. The anti-theft device for skis according to any of the preceding claims, characterized in that said groove has the shape of an internal body removable with respect to the box-like element.

8. The anti-theft device for skis according to claim 7, characterized in that said internal body is preferably realized from thermoplastic vinyl resin.

9. The anti-theft device for skis according to claim 7, characterized in that said internal body is preferably made from polymerized PVC.

10. The anti-theft device for skis according to any of claims 7 through 9 characterized in that said internal body comprises means for fastening the same to the box-like element.

11. The anti-theft device for skis according to any of the preceding claims, characterized in that said groove comprises cross ribs.

12. The anti-theft device for skis according to any of the preceding claims, characterized in that said groove comprises at least a drain channel.

13. The anti-theft device for skis according to any of the preceding claims, characterized in that said box-like element is made from metal.

14. The anti-theft device for skis according to any of the preceding claims, characterized in that said locking means of the box-like element comprise a key-lock.

15. The anti-theft device for skis according to any of the preceding claims, characterized in that said box-like element comprises a coin-activated device for the release of said key from the lock.

16. The anti-theft device for skis according to any of the preceding claims, characterized in that said box-like element comprises supporting means.

17. The anti-theft device for skis according to claim 16, characterized in that said supporting means comprise a shaped element provided with an end that can be fixed in a seat of the box-like element and an end that can be engaged with a tubular element.

18. The anti-theft device for skis according to claim 17, characterized in that said shaped element is constituted of three separate parts that can be associated with each other to define a tubular seat and a supporting portion.

19. The anti-theft device for skis according to claim 16, characterized in that said supporting means comprise a plate that can be fixed to the box-like element and the wall.

20. A supporting means for a box-like shaped element provided on the opposite ends with slots to house said supporting means, characterized in that it comprises a shaped element provided with an end that can be fixed in a seat of the box-like element and an end that can engage with a tubular element.

21. A supporting means according to claim 20, characterized in that said shaped element is constituted of three separate parts that can be associated with each other to define a tubular seat and a supporting portion.
